(19) United States
(12) Patent Application Publication
(10) Pub. No.: US 2026/0113666 A1
(43) Pub. Date: Apr. 23, 2026

(54) RESOURCE INDICATION IN A COMMUNICATION NETWORK

(71) Applicant: TOYOTA JIDOSHA KABUSHIKI KAISHA, Toyota-shi, Aichi-ken (JP)

(72) Inventors: Claude ARZELIER, Varna (BG); Berthold PANZNER, Holzkirchen (DE); Takayuki SHIMIZU, Mountain View, CA (US); Kai-Erik SUNELL, Naantali (FI); Daniel MEDINA, Munchen (DE); Nuno KIILERICH PRATAS, Gistrup (DK); Thomas JACOBSEN, Noerresundby (DK); Torsten WILDSCHEK, Gloucester (GB); Renato BARBOSA ABREU, Aalborg (DK)

(73) Assignee: TOYOTA JIDOSHA KABUSHIKI KAISHA, Toyota-shi, Aichi-ken (JP)

(21) Appl. No.: 19/116,997

(22) PCT Filed: Sep. 11, 2023
(86) PCT No.: PCT/JP2023/033060

§ 371 Date: Mar. 28, 2025

Related U.S. Application Data
(60) Provisional application No. 63/377,568, filed on Sep. 29, 2022.

(51) Int. Cl. H04W 28/26; H04L 1/00; H04W 52/36; H04W 92/18

(52) U.S. Cl. CPC H04W 28/26; H04L 1/0003; H04W 52/367; H04W 92/18

(57) ABSTRACT

Disclosed are methods, apparatuses, and systems for providing a resource indication in a communication. The methods include: determining an overlap between a first resource reserved by a first node and a second resource reserved by a second node; and transmitting one or more indications indicating the overlap between the first resource and the second resource.

### CROSS-REFERENCE TO RELATED PATENT APPLICATION

This application claims the benefit of U.S. Provisional Application No. 63/377,568, filed on Sep. 29, 2022, entitled “RESOURCE INDICATION IN SIDELINK COMMUNICATION,” the entirety of which is incorporated by reference herein.

### TECHNICAL FIELD

Apparatuses and methods consistent with the present disclosure relate generally to communications, more specifically, methods, systems, and devices for indicating an overlap of resources in a communication.

### BACKGROUND ART

Sidelink communication technology enables direct communication between two or more devices. When a first user equipment (UE) in a sidelink communication shares radio resources with a second UE in the same or a different sidelink communication, there may be a conflict in resource selection, for example, due to an overlap of the resources reserved by the first UE and the resources reserved by the second UE. Depending on the level of the overlap, the first UE or the second UE may need to make a proper adjustment, for example, by vacating part or all of the reserved resources, or changing transmission power, etc. Currently, there is no flexible and accurate way of indicating the level of overlap, causing inefficient resource selection and even unnecessary waste of resources. Improved systems and methods for flexibly and efficiently indicating an overlap of resources are desired.

The resource selection procedure of 3rd Generation Partnership Project (3GPP) Release 16/17 5G New Radio (NR) vehicle-to-everything (V2X) PC5 mode 2 is specified in 3GPP Technical Specification (TS) 38.213, TS 38.214, and TS 38.321. For resource selection, a UE performs channel sensing in a sensing window and collects another UE's resource reservation information based on sidelink control information (SCI) decoding to identify candidate resources in a selection window T (T=[T₁, T₂]). First, the UE excludes some time slots from the selection window due to unmonitored resources in the sensing window that the UE cannot sense due to its own transmission (i.e., half-duplex constraint). Then, the UE further excludes resources reserved by other UEs from the selection window if the corresponding sidelink-reference signal received power (SL-RSRP) exceeds the (pre-)configured SL-RSRP exclusion threshold. After resource exclusion, the number of candidate resources shall be at least X % of the total number of resources in the selection window. Otherwise, the UE increases SL-RSRP exclusion threshold by 3 dB until obtaining at least X % resources, where X is (pre-)configured from {20, 35, 50}%. Finally, the UE randomly selects resources among candidate resources in the selection window. The selected frequency resource can be used for multiple times with a fixed time interval for subsequent transmissions (i.e., semi-persistent scheduling (SPS)) or only once (i.e., one-shot transmission (OST)). Also, the UE can retransmit packets multiple times (i.e., hybrid automatic repeat request (HARQ) retransmissions) with or without feedback from receiver UEs to improve the reliability.

In order for a UE to perform sensing and obtain information to receive other UEs' packets, the UE decodes sidelink control information (SCI) first. In Release 16, there are 1^{st}-stage SCI (SCI format 1-A) and 2^{nd}-stage SCI (SCI format 2-A or 2-B) as defined in 3GPP TS 38.212. 1^{st}-stage SCI carries resource reservation information for future transmissions, as well as information about resource allocation and modulation and coding scheme (MCS) for physical sidelink shared channel (PSSCH), demodulation reference signal (DMRS) pattern, 2^{nd}-stage SCI format, etc. 2^{nd}-stage SCI carries control information for HARQ procedures, source/destination IDs, information for distance-based groupcast (UE's zone identification (ID) and communication range requirement), etc. Based on the resource reservation contained in 1^{st}-stage SCI, each UE avoids using time/frequency resources reserved by other UEs when it performs resource (re-)selection.

In Release 17 5G NR-V2X PC5 mode 2, inter-UE coordination (IUC) is introduced, in which a first UE (UE-A) sends coordination information about resources to a second UE (UE-B), and the UE-B utilizes that information for its resource (re-)selection. The following two schemes of inter-UE coordination are supported:
IUC scheme 1: A UE-A can provide to a UE-B indications of resources that are preferred to be included in the UE-B's (re-)selected resources, or preferred to be excluded. When given resources to include, the UE-B may rely only on those resources, at least if it does not support sensing/resource exclusion, or may combine them with resources identified by its own sensing procedure, before making a final selection. The indication from the UE-A to the UE-B is sent in medium access control (MAC) control element (CE) and/or 2^{nd}-stage SCI.
IUC scheme 2: A UE-A can provide to a UE-B an indication that resources reserved for UE-B's transmission (which may or may not be to the UE-A) will be, or could be, subject to conflict with a transmission from another UE. Then, the UE-B re-selects new resources to replace them. The indication from the UE-A to the UE-B is sent in a physical sidelink feedback channel (PSFCH).

### SUMMARY OF INVENTION

Some embodiments of the present disclosure involve a method for providing a resource indication in a communication. The method includes determining an overlap between a first resource reserved by a first node and a second resource reserved by a second node; and transmitting one or more indications indicating the overlap between the first resource and the second resource.

According to some embodiments of the present disclosure, there is provided a method for obtaining one or more resource indications in a communication. The method includes reserving, by a first node, a first resource for the communication; receiving, by the first node, one or more indications indicating an overlap between the reserved first resource and a second resource reserved by a second node; and performing, by the first node, an adjustment based on the one or more indications so as to mitigate an effect of the overlap.

According to some embodiments of the present disclosure, there is provided an apparatus for providing one or more resource indications. The apparatus includes a memory storing an instruction; and a processor configured to execute the instruction stored in the memory to: determine an overlap between a first resource reserved by a first node and a second resource reserved by a second node; and transmit one or more indications indicating the overlap between the first resource and the second resource.

According to some embodiments of the present disclosure, there is provided a first node for obtaining resource indications in a communication. The first node includes a memory storing an instruction; and a processor configured to execute the instruction stored in the memory to: reserve a first resource for the communication; receive one or more indications indicating an overlap between the reserved first resource and a second resource reserved by a second node; and perform an adjustment based on the one or more indications so as to mitigate an effect of the overlap.

According to some embodiments of the present disclosure, there is provided a non-transitory computer-readable medium storing instructions that are executable by one or more processors of an apparatus for communication, to perform a method. The method includes determining an overlap between a first resource reserved by a first node and a second resource reserved by a second node; and transmitting one or more indications indicating the overlap between the first resource and the second resource.

According to some embodiments of the present disclosure, there is provided a non-transitory computer-readable medium storing instructions that are executable by one or more processors of a first node for a communication. The method includes reserving a first resource for the communication; receiving one or more indications indicating an overlap between the reserved first resource and a second resource reserved by a second node; and performing an adjustment based on the one or more indications so as to mitigate an effect of the overlap.

### BRIEF DESCRIPTION OF DRAWINGS

FIG. 1 is a flow chart illustrating a method for resource selection in a communication, consistent with some embodiments of the present disclosure.

FIG. 2 is a schematic diagram illustrating a resource candidate determination procedure according to the method of FIG. 1, consistent with some embodiments of the present disclosure.

FIG. 3 is a flow chart illustrating a method for resource selection in a communication, consistent with some embodiments of the present disclosure.

FIG. 4A is a schematic diagram illustrating a resource candidate determination procedure according to the method of FIG. 3, consistent with some embodiments of the present disclosure.

FIG. 4B is a table showing a correspondence between sub-carrier spacing (SCS) and a subset of resources according to the method of FIG. 3, consistent with some embodiments of the present disclosure.

FIG. 5 is a schematic diagram illustrating dynamic co-channel coexistence of a first sidelink communication and a second sidelink communication, consistent with some embodiments of the present disclosure.

FIG. 6 is a schematic diagram illustrating device types for dynamic co-channel coexistence of a first sidelink communication and a second sidelink communication, consistent with some embodiments of the present disclosure.

FIG. 7 is a flow chart illustrating a method for resource indication in a communication, consistent with some embodiments of the present disclosure.

FIG. 8 is a flow chart illustrating a method for obtaining one or more resource indications in a communication, consistent with some embodiments of the present disclosure.

FIG. 9 is a block diagram of a node for communication, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

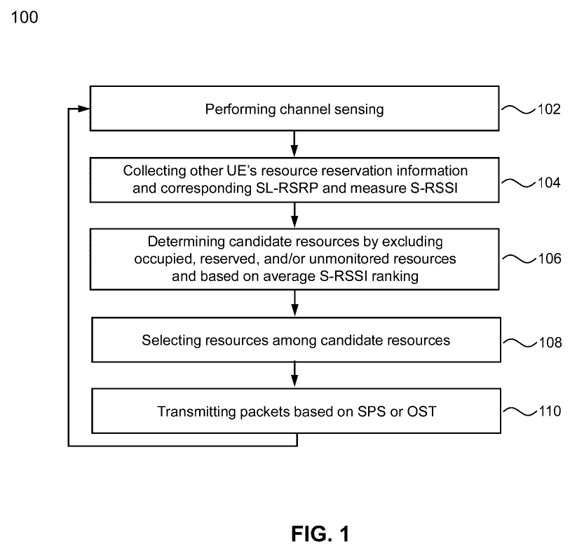

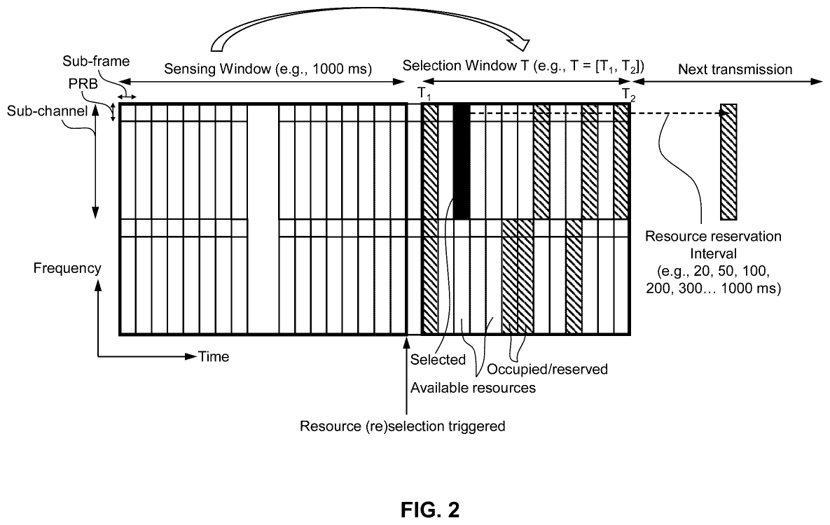

FIG. 1 is a flow chart illustrating a method 100 (referred to as the “first method” in this disclosure) for resource selection in a communication; and FIG. 2 is a schematic diagram illustrating a resource candidate determination procedure according to the first method, consistent with some embodiments of the present disclosure. The method 100 may be performed by a UE in a sidelink communication. For example, the method 100 may be performed by a vehicle in a vehicle-to-everything (V2X) communication. The method 100 may be performed under a mode (referred to as the “first mode” in this disclosure) that employs discrete Fourier transform spread orthogonal frequency division multiplexing (DFT-s-OFDM) for sidelink at the physical (PHY) layer. An example of the first mode is the 3GPP Release 14/15 Long-Term Evolution (LTE) V2X PC5 mode 4.

As shown in FIG. 2, in the first mode, the time-frequency radio resources are divided into sub-frames in the time domain and sub-channels in the frequency domain. In an embodiment, the first mode may only support 15 kHz sub-carrier spacing. Each sub-frame may be 1 ms length and may consist of 14 DFT-s-OFDM symbols. Each sub-channel may consist of multiple contiguous physical resource blocks (PRBs), where each PRB occupies 180 kHz and consists of 12 subcarriers with 15 kHz SCS. The size of sub-channel (i.e., the number of PRBs per sub-channel) may be configurable or preconfigurable. To cope with high Doppler caused by high relative speed in vehicular scenarios, the density of DMRS, which is used for frequency offset compensation and channel estimation, may be set to four per sub-frame. Each UE may broadcast data (e.g., TB) in the PSSCH and SCI in the PSCCH. The PSCCH may occupy two contiguous PRBs. The number of PRBs for PSSCH may be configurable or preconfigurable. The SCI format may contain information to decode the corresponding TB in PSSCH and facilitate UE autonomous resource selection. As shown in FIG. 2, the resource reservation interval can be set to one of the allowed values (e.g., 20, 50, 100, 200, 300 . . . 1000 ms). PSCCH and the corresponding PSSCH may be transmitted in the same sub-frame in either adjacent or non-adjacent PRBs in the frequency domain.

Referring to FIG. 1, method 100 includes a step 102 of performing a channel sensing (e.g., background sensing or any other type of full sensing or partial sensing). For example, as shown in FIG. 2, for resource selection, a UE may perform a channel sensing in a sensing window (e.g., 1000 ms) to collect another UE's resource reservation information. The sensing window can be any time duration, depending on the UE implementation.

Referring back to FIG. 1, the method 100 includes a step 104 of collecting another UE's resource reservation information and corresponding SL-RSRP, and measuring sidelink received signal strength indicator (S-RSSI). For example, the UE may collect resource reservation information of other UEs and the corresponding SL-RSRPs. The UE may also measure the S-RSSI using received sidelink signals. The UE may decode received SCI included in the received sidelink signals to identify candidate resources in a selection window T (e.g., T=[T₁, T₂], where T₁≤4 ms, and 20≤T₂≤100 ms), as shown in FIG. 2. The selection of the T₁ and T₂ values depends on the UE implementation.

The method 100 includes a step 106 of determining candidate resources by excluding occupied, reserved, and/or unmonitored resources and based on an average S-RSSI ranking. For example, as shown in FIG. 2, once the resource selection or reselection is triggered, the UE may exclude some sub-frames from the selection window. The excluded sub-frames may be the resources not monitored in the sensing window. The UE may not sense these resources due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least 20% of the total number of resources in the selection window. Otherwise, the UE may increase the SL-RSRP exclusion threshold by, for example, 3 dB until the candidate resources reaches at least 20% of the total resources. The UE may further calculate the corresponding S-RSSI of each sub-channel resource as a linear average over the S-RSSIs of the monitored resources with a certain interval (e.g., the averaging interval is 100 ms for a resource reservation interval of greater than or equal to 100 ms). The UE may determine, for example, 20% best resources in terms of lowest average S-RSSI as the candidate resources among the total resources in the selection window. The UE may use the 20% resources with the lowest average S-RSSI based on S-RSSI ranking as candidate resources.

The method 100 includes a step 108 of selecting resources among candidate resources. The selection of the resources among the candidate resources may be a random selection. For example, as shown in FIG. 2, the UE may select a single-subframe resource in a uniformly random manner among candidate single-subframe resources. The selected frequency resource can be used for multiple times with a fixed time interval for subsequent transmissions (this scheme is referred to as SPS in this disclosure) or only once (this scheme is referred to as OST in this disclosure).

The method 100 includes a step 110 of transmitting packets based on SPS or OST. The packets can be initial or retransmitted packets. For example, the UE may transmit an initial packet using the selected resources. For another example, the UE may retransmit a packet up to one time without feedback from receiver UEs to improve reliability of the transmission (this is referred to as “blind HARQ retransmission” in this disclosure). After the transmission, the method may start again from the step 102.

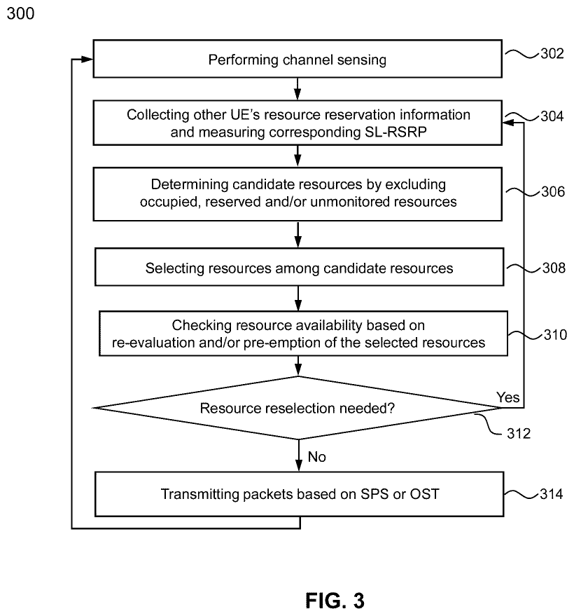

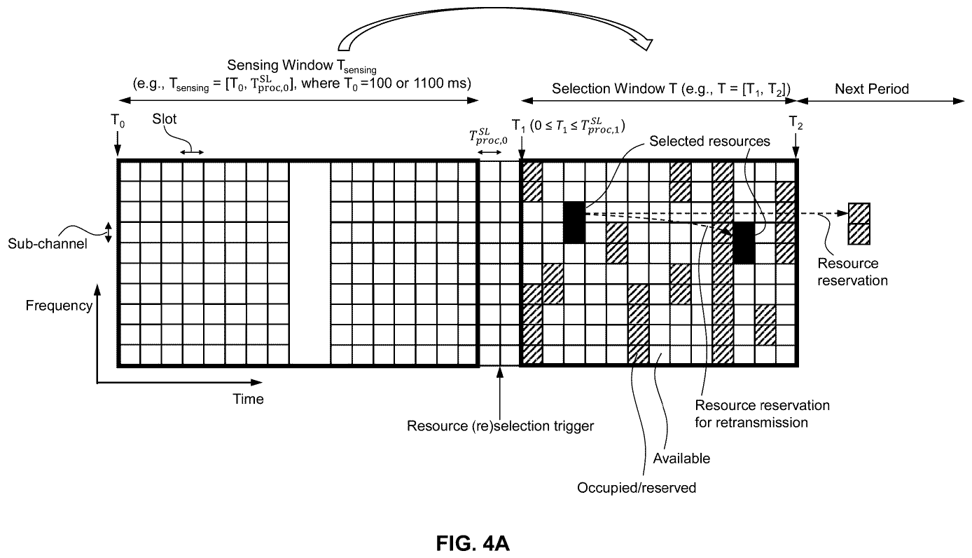

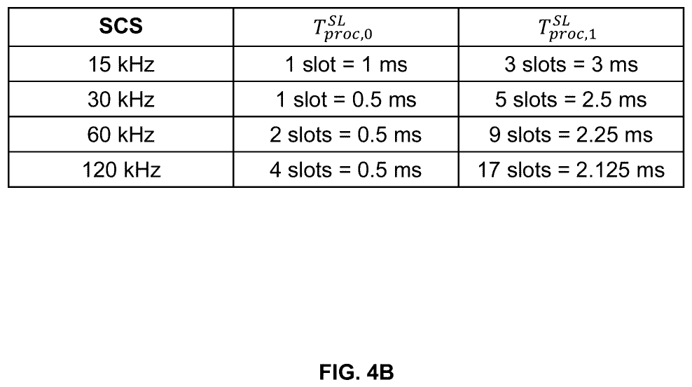

FIG. 3 is a flow chart illustrating a method 300 (referred to as the “second method” in this disclosure) for resource selection in a communication; FIG. 4A is a schematic diagram illustrating a resource candidate determination procedure according to the second method; and FIG. 4B is a table showing a correspondence between SCS and a subset of resources according to the second method, consistent with some embodiments of the present disclosure. The method 300 may be performed by a UE in a sidelink communication. For example, the method 300 may be performed by a vehicle in a V2X communication. The method 300 may be performed under a mode (referred to as the “second mode” in this disclosure) that employs orthogonal frequency division multiplexing (OFDM) at the PHY layer for a sidelink communication. An example of the second mode is the 3GPP Release 16/17 5G NR-V2X PC5 mode 2.

As shown in FIG. 4A, in the second mode, the time-frequency radio resources are divided into slots in the time domain and sub-channels in the frequency domain. In an embodiment, the second mode may support SCSs of 15·2^{μ} kHz, where p is the OFDM numerology μμ{0, 1, 2, 3, 4}. For sub-6 GHz frequency, SCSs of 15, 30, and 60 kHz (i.e., μμ{0, 1, 2}) may be supported, whereas for above 6 GHz frequency, SCSs of 60, 120, and 240 kHz (i.e., μ{2, 3, 4}) may be supported. Each slot is 1/2^{μ} ms length and consists of 14 OFDM symbols. Each sub-channel may consist of multiple contiguous PRBs, where each PRB occupies 180·2^{μ} kHz and consists of 12 subcarriers with 15·2^{μ} kHz SCS. The size of sub-channel (i.e., the number of PRBs per sub-channel) is configurable or preconfigurable. To support multiple SCSs and different Doppler spreads, multiple DMRS density options (2˜4 DMRS symbols per slot) are supported. Each UE may transmit a first stage SCI in the PSCCH and data (TB), and a second stage SCI in the PSSCH. HARQ feedback (e.g., acknowledgement (ACK)/negative acknowledgement (NACK) or NACK only) may be transmitted in the PSFCH.

FIG. 4B shows the correspondence among SCS and parameters for the sensing window and selection window (T^{SL}_{proc,0} and T^{SL}_{proc,1}), consistent with some embodiments of the present disclosure. For example, when the SCS is 15 kHz, as shown in the second and third columns of FIG. 4B, T^{SL}_{proc,0} corresponds to 1 ms, and T^{SL}_{proc,1} correspond to 3 ms. As another example, when the SCS is 30 kHz, T^{SL}_{proc,0} corresponds to 0.5 ms, and T^{SL}_{proc,1} correspond 2.5 ms.

Referring back to FIG. 3, the method 300 includes a step 302 of performing a channel sensing (e.g., a background sensing or any other type of full sensing or partial sensing). For example, as shown in FIG. 4A, a UE may perform a channel sensing in a sensing window T_{sensing} (e.g., T_{sensing}=[To, T^{SL}_{proc,0}], where T₀=100 or 1100 ms and T^{SL}_{proc,0} is given in FIG. 4B) to collect another UE's resource reservation information. The channel sensing with a sensing window of 100 ms may be for an aperiodic traffic, while the channel sensing with a sensing window of 1100 ms may be for a periodic traffic.

The method 300 includes a step 304 of collecting another UE's resource reservation information and measuring corresponding SL-RSRPs. For example, as shown in FIG. 4A, the UE may perform a channel sensing in the sensing window and collect another UE's resource reservation information based on SCI decoding to identify candidate resources. In an embodiment, in order to perform the channel sensing and obtain information to receive other UEs' packets, the UE decodes SCI first. The SCI decoding may include two stages: a first stage SCI (SCI format 1-A) and a second stage SCI (SCI format 2-A or 2-B) as defined in 3GPP specifications. The first stage SCI may carry resource reservation information for future transmissions, information about resource allocation, MCS for PSSCH, DMRS pattern, and the second stage SCI format, etc. The second stage SCI may carry control information for HARQ procedures, source/destination IDs, information for distance-based groupcast (e.g., UE's zone ID and communication range requirement), etc. Based on the resource reservation information contained in the first stage SCI, the UE may avoid using time and/or frequency resources reserved by other UEs when the UE performs resource selection or reselection.

The method 300 may support inter-UE coordination in which a first UE (UE-A) sends coordination information about resources to a second UE (UE-B), and the UE-B utilizes that information for its resource selection or reselection. In some embodiments, the UE may support a first inter-UE coordination scheme. In the first inter-UE coordination scheme, the UE may receive from another UE indications of resources that are preferred to be included in the UE's selected or reselected resources, or preferred to be excluded. In an embodiment, when an indication of resources indicates inclusion of given resources, the UE may solely rely on those resources, if the indication does not support sensing and/or resource exclusion. In an embodiment, the UE may also combine the indication of resources with resources identified by its own sensing procedure before making a final selection. The UE may receive the indication via MAC CE and/or 2nd-stage SCI. In some embodiments, the UE may support a second inter-UE coordination scheme. In the second inter-UE coordination scheme, the UE may receive an indication that resources reserved for the UE's transmission will be, or could be, subject to conflict with a transmission from another UE. In this case, the UE may re-select new resources. The UE may receive indication via PSFCH. The UE may use a mapping table that defines a mapping rule between PSSCH allocation (slots and sub-channels) and PSFCH resources. Using the mapping table, the UE (and the transmitter UE) can determine the PSSCH allocation (slot(s) and sub-channel(s)) that the information in the PSFCH resource refers to. When more than one sub-channel is reserved in the PSSCH, multiple PSFCH resources may be used. The mapping table may be pre-defined, pre-configured at the UE, or configured by a network node.

The method 300 includes a step 306 of determining candidate resources by excluding occupied, reserved, and/or unmonitored resources. For example, the UE may exclude unmonitored slots from the selection window T (e.g., T=[T₁, T₂], where 0≤T₁≤T^{SL}_{proc,1} ms, T^{SL}_{proc,1} is given in FIG. 4B, and T₂ may be set based on the remaining packet delay budget). The UE may fail to sense the unmonitored slots in the sensing window due to, for example, its own transmission (e.g., half-duplex constraint). The UE may further exclude resources occupied or reserved by other UEs from the selection window if the corresponding SL-RSRP exceeds a configured or preconfigured SL-RSRP exclusion threshold. After resource exclusion, the number of candidate resources may be at least X % of the total number of resources in the selection window. Otherwise, the UE may increase the SL-RSRP exclusion threshold by, for example, 3 dB until at least X % resources are obtained, where X may be configured or preconfigured from {20, 35, 50}%.

The method 300 includes a step 308 of selecting resources among candidate resources. The selection may be a random selection. For example, as shown in FIG. 4A, the UE may select resources among candidate resources in the selection window. The selected frequency resource can be used multiple times with a fixed time interval for SPS or OST.

The method 300 includes a step 310 of checking resource availability based on re-evaluation and/or pre-emption of the selected resources. This step may be performed for the late-arriving packets (e.g., aperiodic packets) after resource selection and before the packet transmission.

The method 300 includes a step 312 of determining whether a resource reselection is needed. If it is determined that a resource reselection is needed, the method may iterate from the step 304. On the other hand, if it is determined that a resource reselection is not needed, the method may proceed with a step 314 of transmitting packets based on SPS or OST. The packets may be initial packets or retransmitted packets. The UE may also retransmit packets multiple times (e.g., HARQ retransmissions) with or without feedback from receiver UEs to improve reliability of the transmission.

Some embodiments of the present disclosure are directed to resource selection or reselection for co-channel coexistence of two or more sidelink communications (e.g., the sidelink communication described in relation to FIGS. 1-2 and the sidelink communication described in relations to FIG. 3-4B).

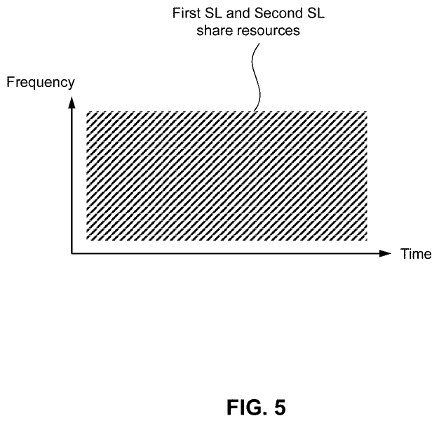

FIG. 5 is a schematic diagram illustrating dynamic co-channel coexistence of a first sidelink (SL) communication and a second sidelink (SL) communication, consistent with some embodiments of the present disclosure. In an embodiment, the first sidelink communication is NR sidelink communication and the second sidelink communication is LTE sidelink communication. As shown in FIG. 5, the first sidelink communication and the second sidelink communication share time and/or frequency resources. However, the methods described in this disclosure are not so limited. The methods described in this disclosure can be applied to any sidelink communications, for example, a future generation (6^{th} generation (6G), 7^{th} generation (7G), or any future generation) sidelink communications. Moreover, the methods described in this disclosure can also be applied to downlink/uplink communications between a base station and a UE.

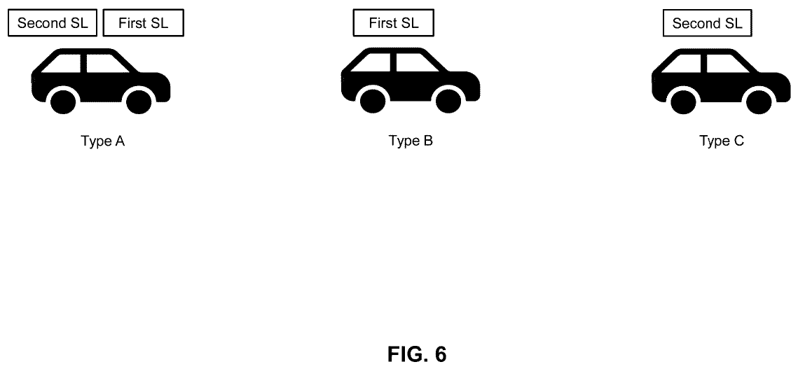

FIG. 6 is a schematic diagram illustrating device types for dynamic co-channel coexistence of a first sidelink (SL) communication and a second sidelink (SL) communication, consistent with some embodiments of the present disclosure. Referring to FIG. 6, at least three types (Type A, Type B, and Type C) of devices are considered in this disclosure. A Type A device includes a module for the first sidelink communication and a module for the second sidelink communication. A Type B device only includes a module for the first sidelink communication. A Type C device only includes a module for the second sidelink communication. For example, in an embodiment, a Type A device includes both LTE SL and NR SL modules; a Type B device only includes an NR SL module; and a Type C device only includes an LTE SL module.

Sometimes, sidelink resources selected by one UE may partially or fully overlap with sidelink resources selected by another UE. When the overlap is severe (full overlap), one of the two UEs may need to vacate the selected resources or exclude the resources from selection. However, when the overlap is minor or negligible, the UEs may not need to exclude resources or vacate resources. At least some embodiments of the present disclosure provide flexible and an easy way of indicating the level of overlap such that a UE can accurately determine whether to exclude/vacate resources, thereby efficiently mitigating conflict in resource selection and saving radio resources.

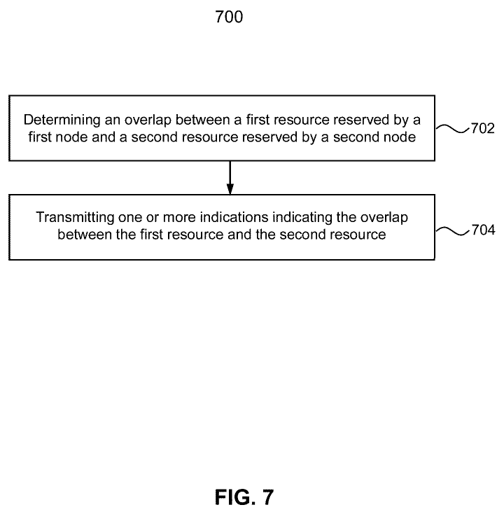

FIG. 7 is a flow chart illustrating a method 700 for resource indication in a communication (e.g., a sidelink communication), consistent with some embodiments of the present disclosure. The method 700 may be performed by a node in a communication. The node can be a network node (e.g., base station eNB, gNB), a road side unit, a relay node, a mobile equipment, or a UE.

The method 700 includes a step 702 of determining an overlap between a first resource reserved by a first node and a second resource reserved by a second node. In an embodiment, the overlap between the first resource and the second resource is determined by at least one of the second node, or a third node that is different from the first and second nodes. In an embodiment, at least one of the first node or the second node is a UE in a sidelink communication. In an embodiment, at least one of the first node or the second node is a base station. In an embodiment, the first node is a UE, and the second node is a base station. The third node can be a network node (e.g., base station eNB, gNB), a road side unit, a relay node, a mobile equipment, or another UE. For example, in an embodiment, the second node may determine the overlap between the first resource reserved by the first node and the second resource reserved by the second node. The second node may perform a channel sensing in a sensing window (e.g., 100 or 1100 ms) to obtain information regarding the first resource reserved by the first node. Alternatively, or additionally, the second node may use inter-UE coordination information, in which one or more other UEs send information about the first resource to the second node.

The first resource reserved by the first node may be one or more resources in the time domain and/or the frequency domain. For example, the first resource may include at least one of: one or more slots, one or more subframes, one or more frames, one or more subchannels, one or more channels, or one or more resource blocks. Similarly, the second resource reserved by the second node may be one or more resources in the time domain and/or the frequency domain. For example, the second resource may include at least one of: one or more slots, one or more subframes, one or more frames, one or more subchannels, one or more channels, or one or more resource blocks.

The first resource and the second resource may be resources for a same radio access technology (RAT) or resources for different RATs. For example, in an embodiment, the first resource may be the resources for an NR sidelink communication, and the second resource may be the resources for an LTE sidelink communication. The method 700 includes a step 704 of transmitting one or more indications indicating the overlap between the first resource and the second resource. The one or more indications may be transmitted to the first node, or a third node that is different from the first and second nodes. For example, the second node or a third node may determine the overlap between the first resource and the second resource and transmit one or more indications indicating the overlap between the first resource and the second resource to the first node or another third node.

The one or more indications may be transmitted over at least one of: PSFCH, a PSSCH, a PSCCH, or a MAC CE.

In some embodiments, the one or more indications are transmitted internally within the first node. For example, the first node may be a Type A UE as shown in FIG. 6, and thus include a first module for a first sidelink communication and a second module for a second sidelink communication. The first module of the first node may determine the overlap between the first resource and the second resource and transmit the one or more indications to the second module of the first node.

In an embodiment, the first resource and the second resource are resources for the same RAT. For example, the first resource and the second resource may be the resources for an LTE or NR sidelink communication. In this embodiment, the one or more indications may include an indication indicating the same RAT.

In an embodiment, the first resource is a resource for a first RAT, and the second resource is a resource for a second RAT that is different from the first RAT. For example, the first resource may be the resources for an NR sidelink communication, and the second resource may be the resources for an LTE sidelink communication. In this embodiment, the one or more indications may include an indication indicating the first RAT and the second RAT being different from one another.

In some embodiments, the one or more indications may include a plurality of indications. In these embodiments, the method 700 may further include configuring or pre-configuring the plurality of indications based on a level of overlap. The level of overlap may be indicated as percentage of overlap. Each of the plurality of indications may correspond to at least one of: a percentage of the overlap in the time domain, a percentage of the overlap in the frequency domain, or an overall percentage of the overlap in the time domain and in the frequency domain. For example, in some embodiments, the one or more indications are the PSFCH feedbacks, and the number of indications indicating the percentage of the overlap may be configured or pre-configured. For example, as shown in Table 1 below, when there is a 0% to 10% overlap of resources, the PSFCH feedback may be sent using Indication 1; when there is a 10% to 80% overlap of resources, the PSFCH feedback may be sent using Indication 2; and when there is an 80% to 100% overlap of resources, the PSFCH feedback may be sent using Indication 3.

TABLE 1
Exemplary percentages of overlap and corresponding indications

| Percentage of Overlap | Indication |
|---|---|
| 0% ≤ overlap < 10% | Indication 1 |
| 10% ≤ overlap < 80% | Indication 2 |
| 80% ≤ overlap ≤ 100% | Indication 3 |

In some embodiments, the one or more indications may include at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots. For example, in some embodiments, the one or more indications may include information on which part of the resource is overlapping, such as “upper”, “lower”, and/or “middle” part of the reserved contiguous subchannels and/or “earlier”, “later”, and/or “middle” part of the reserved slot (or subframe).

In some embodiments, the one or more indications may include a plurality of indications including a first indication and a second indication. The first indication may indicate a higher level of the overlap of resources than the second indication. In this case, at least a portion of the first resource may be vacated or excluded if the first node receives N1 times of the first indication, or if the first node receives N2 times of the second indication, where N1 and N2 are integers and N1 is smaller than N2. The N1 and the N2 can be configured by a network or pre-configured in the first node.

In some embodiments, the one or more indications may include a plurality of indications, each of the plurality of indications being assigned a priority (e.g., prose per-packet priority (PPPP) used in LTE or priority level/PC5 quality-of-service (PQI) used in NR) or a relative priority. In these embodiments, the first UE may first consider overlap of resources corresponding to the indication having a highest priority.

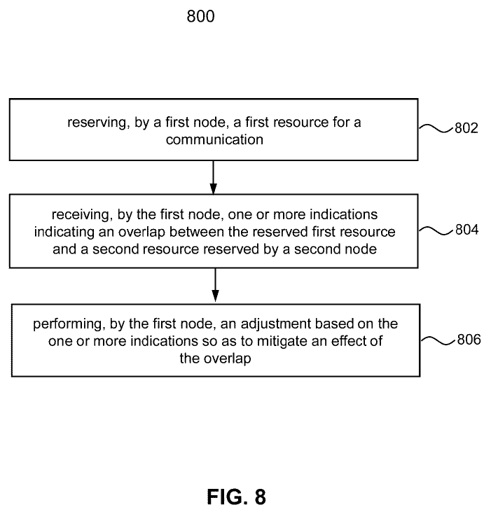

FIG. 8 is a flow chart illustrating a method 800 for obtaining one or more resource indications in a communication, consistent with some embodiments of the present disclosure.

The method 800 includes a step 802 of reserving, by a first node, a first resource for the communication. The first node may be a UE, a base station, a road side unit, a relay node, or a mobile equipment. For example, in an embodiment, the first node may be a UE in a sidelink communication and may determine one or more candidate resources via a channel sensing, and select one or more resources for transmission or reception from the candidate resources. Alternatively, or additionally, the first node may use inter-UE coordination information, in which one or more other nodes send information about the first resource to be reserved to the first node. The first resource reserved by the first node may be one or more resources in the time domain and/or the frequency domain. For example, the first resource may include at least one of: one or more slots, one or more subframes, one or more frames, one or more subchannels, one or more channels, or one or more resource blocks.

The method 800 includes a step 804 of receiving, by the first node, one or more indications indicating an overlap between the reserved first resource and a second resource reserved by a second node. The second node may be a UE, a base station, a road side unit, a relay node, or a mobile equipment. For example, in an embodiment, the second node may be a UE in a sidelink communication. The first node may receive the one or more indications from the second node, a network node (e.g., a base station), a road side unit, a relay node, a mobile equipment, or any other UE different from the first and second nodes.

The second resource reserved by the second node may be one or more resources in the time domain and/or the frequency domain. For example, the second resource may include at least one of: one or more slots, one or more subframes, one or more frames, one or more subchannels, one or more channels, or one or more resource blocks.

In an embodiment, the first node may receive the one or more indications indicating an overlap between the reserved first resource and a second resource reserved by a second UE, internally, for example, from an internal module. In an embodiment, the one or more indications are also transmitted to a third node that is different from the first and second nodes.

In some embodiments, the first resource and the second resource are resources for the same RAT, and the one or more indications may include an indication indicating the same RAT. For example, the first resource and the second resource may be the resources for an NR sidelink communication or an LTE sidelink communication.

In some embodiments, the first resource is a resource for a first RAT, the second resource is a resource for a second RAT that is different from the first RAT, and the one or more indications may include an indication indicating the first RAT and the second RAT being different from one another. For example, the first resource may be the resource for an NR sidelink communication and the second resource may be the resource for an LTE sidelink communication.

The first node may receive the one or more indications over at least one of: a PSFCH, a PSSCH, a PSCCH, or a MAC CE. For example, in an embodiment, the indication may indicate a sub-frame for LTE sidelink communication overlaps with a number of slots for NR sidelink communication. In this case, the one or more indications of the overlapping resources may be delivered to the first node as the number of overlapping PSSCH slots over the PSFCH resource that maps to the overlapping PSSCH slots.

In some embodiments, the one or more indications may include a plurality of indications, each of the plurality of indications corresponding to at least one of: a percentage of the overlap in a time domain, a percentage of the overlap in a frequency domain, or an overall percentage of the overlap in the time domain and in the frequency domain.

In some embodiments, each of the first resource and the second resource may include at least one of: one or more slots, one or more subframes, one or more frames, one or more subchannels, one or more channels, or one or more resource blocks. In some embodiments, the one or more indications may include at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

The method 800 includes a step 806 of performing, by the first node, an adjustment based on the one or more indications so as to mitigate an effect of the overlap. For example, upon receipt of the one or more indications, the first node may make an adjustment, depending on the level of overlap. In some embodiments, performing the adjustment based on the one or more indications may include at least one of: determining whether to vacate at least a portion of the reserved first resource; determining whether to exclude at least a portion of a resource to be selected; changing a MCS for the first node; changing a transmit power for the first node; or performing a retransmission using an alternative resource reservation.

In an embodiment, performing the adjustment based on the one or more indications may include determining whether to vacate or exclude at least a portion of the first resource based on the one or more indications. For example, the first node may vacate or exclude at least a portion of the first resource (e.g., one or more time slots, one or more sub-frames, one or more sub-channels, one or more channels, or one or more resource blocks) if a percentage of the overlap in the frequency domain and/or in the time domain exceeds a threshold. The threshold can be configured or pre-configured.

In an embodiment, the one or more indications may include a plurality of indications including a first indication and a second indication, the first indication indicating a higher level of the overlap than the second indication, and at least a portion of the first resource is vacated or excluded if the first UE receives N1 times of the first indication, or if the first UE receives N2 times of the second indication, where N1 and N2 are integers and N1 is smaller than N2. The N1 and the N2 may be configured by a network or pre-configured in the first UE.

In an embodiment, the one or more indications may include a plurality of indications, and performing the adjustment based on the one or more indications may include changing the MCS for the first node based on the plurality of the indications. The MCS may correspond to at least one of a type or a number of the one or more indications. In this embodiment, a set of MCSs may be configured or pre-configured, each of the set of MCSs corresponding to each of the plurality of indications.

In an embodiment, in performing the adjustment based on the one or more indications, the first UE may consider priorities (e.g., PPPP used in LTE or priority level/PC5 PQI used in NR) or relative priorities of transmissions scheduled to use the first resource. For example, the first UE may not vacate or exclude the resource if the associated transmission is of higher priority (more important) than that of overlapping transmission. In some embodiments, the priority or relative priorities may be used in combination with other embodiments in this disclosure. For example, by combining the priority and the underlying RATs, a mapping rule can be created. The mapping rule may take as input the information on same RAT (or not), and the relative priority of the potential transmissions, to decide whether or not to vacate/exclude the resource. In some embodiments, the first UE only considers overlap of the PSSCH.

In an embodiment, in performing the adjustment based on the one or more indications, the first UE considers the one or more indications only when a distance between the first node and an apparatus at which the overlap is determined is smaller than a threshold distance. The threshold distance can be pre-defined, pre-configured, or configured.

In an embodiment, performing the adjustment based on the one or more indications includes changing the transmit power for the first node based on the plurality of the indications. For example, the first UE uses a reduced transmit power for a transmission having a lower priority, and increased transmit power for a transmission having a higher priority.

In an embodiment, the one or more indications may include a plurality of indications transmitted from a single node at a same time. In an embodiment, the one or more indications may include a plurality of indications transmitted from a single node at different times. In an embodiment, the one or more indications may include a plurality of indications transmitted from a plurality of different nodes. In these embodiments, the method 800 may further include aggregating the plurality of indications at least in one of a time domain or a frequency domain, so as to generate at least one of a time domain aggregation or a frequency domain aggregation. For example, the plurality of indications may be aggregated based on content, source (e.g., from the same node), time of transmission, type (time domain resource or frequency domain resource), etc. The method 800 may further include determining whether a percentage of an overlap of at least one of the time domain aggregation or the frequency domain aggregation is greater than a time domain threshold or a frequency domain threshold. The time domain threshold and the frequency domain threshold may be configured or pre-configured. The method 800 may further include vacating or excluding at least one resource in the time domain or the frequency domain, in response to a determination that the percentage of the overlap of at least one of the time domain aggregation or the frequency domain aggregation is greater than the time domain threshold or the frequency domain threshold.

In some embodiments, depending on the indication type and/or the number of indications received and/or the amount of overlapping, the first UE may still use the reserved resource, but with a reduced transmit power in order to reduce the interference caused to the overlapping resources. The first UE may adopt this adjustment for a low priority transmission.

In some embodiments, the first UE may still use the reserved resource, but with an increased transmit power in order to overcome the interference caused on the overlapping resource. The first UE may adopt this adjustment for a high priority transmission.

In some embodiments, the decrement or increment in power depends on the level of the overlap of resources. The decrement or increment in power may be configured or pre-configured. The decrement or increment in power may also be associated with the priority of the transmissions.

In some embodiments, depending on the indication type and/or the number of indications received, the first node may perform retransmission using an alternative resource reservation. In some embodiments, depending on the indication type and/or number of indications received, the first node may decide to change the frequency and/or time location of its 2nd stage SCI, if this is indicated to be overlapped.

In some embodiments, the first node may consider an overlap of resources from different RATs as less harmful than an overlap of resources from the same RAT, and the first node may make different adjustment in these two cases. For example, in an embodiment, the first node may vacate or exclude resources when an indication of overlap is received corresponding to the same RAT of the potential transmission and may not vacate or exclude resources otherwise. In another embodiment, the first node may accept more overlap (in overlap percentage, and/or number of indication(s)) within different RATs before deciding to vacate or exclude resources. In some embodiments, a set of possible frequency and/or time locations for the 2nd stage SCI in case of overlapping are configured or pre-configured, so that the first node may perform a blind decoding of the 2nd stage SCI. In some embodiments, the changed frequency and/or time locations for the 2nd stage SCI are indicated by the 1st stage SCI.

In some embodiments, the cyclic shift may be applied to a signal sent in the PSFCH resource element (or the actual PSFCH resource element selection) to indicate whether the overlap is intra-RAT or inter-RAT overlap of resources. In some embodiments, additional cyclic shifts (or alternative resource elements) may be used to indicate the priority of the other resource reservation colliding with the first resource reserved by the first UE.

In some embodiments, when PSFCH is used to carry the one or more indications, the multiple indications are spread over multiple PSFCH resources, so that the multiple indications are carried without introducing a new PSFCH format. For example, PSFCH resource from slot n in subchannel x is used for bit 0, slot n subchannel x+1 for bit 1, and so on.

In some embodiments, the indication may depend on the overall allocated resource, for example, overall allocated sub-channels or overall allocated consecutive sub-channels. For example, if the maximum of three sub-channels can be part of the resource allocation, then the indication could indicate 1, 2, or 3 sub-channel(s).

In some embodiments, the resource allocation uses more than one sub-channel, and the one or more indications are provided only on the PSFCH resources mapped from conflicting sub-channels. In an embodiment, more than two types of triggers may be used.

In some embodiments, the related overlap(s) that trigger the indication(s) may be based on potential transmission resources: (1) between the resource(s) of the node that trigger(s) the indication(s) and the node that receives the indication(s); and/or (2) between the resource(s) of the node that trigger(s) the indication(s) and a third Node (UE or Network); and/or (3) between the resource(s) of two other nodes (e.g., UEs or networks) other than the ones that send and receive the indication(s). In some embodiments, these three cases above may lead to different behaviors for the receiver node (e.g., in terms of indication type to be received and/or its number), and/or may be combined.

In some embodiments, the first node is a Type B UE in a sidelink communication and receives multi-level indications from a Type A UE over the PSFCH. For this, the PSFCH may be enhanced to indicate more than one indication.

In some embodiments, the first node may vacate or exclude the first resource with a pre-established rule. For example, the first node may vacate or exclude the first resource every other time (e.g., it vacates, then does not vacate, then vacates, etc.). In some embodiments, the first node may vacate or exclude the first resource based on a random percentage of chances. The random percentage of chances can be dependent on the indication type and/or the number of received indication.

In some embodiments, the type or the number of the one or more indications may be altered based on the distance between the first node and the node that transmits the one or more indications. In some embodiments, the distance between the first node and a third node may be considered. In some embodiments, the distance between a third node and a fourth node may be considered. In some embodiments, the first node may use the received one or more indications in conjunction with its own resource reservation to decide whether to vacate or exclude the first resource.

The parameters referred to in this disclosure (e.g., the numbers N1, N2, the distance threshold) can be provided to the first node via configuration or pre-configuration. For example, when the first node is in coverage of the network node, the parameters may be provided to the first node by the base station (e.g., gNB) via Radio Resource Control (RRC) message. Alternatively, or additionally, the parameters may be provided to the first node via network configuration, for example, subscriber identity module (SIM)/universal subscriber identity module (USIM) toolkit from the home public land mobile network (PLMN).

Some embodiments of the present disclosure may involve Rel-18 5G NR-V2X PC5 radio and software installed in a vehicle that uses Rel-18 5G NR-V2X PC5 mode 2 for V2X services. Additionally, or alternatively, techniques in this disclosure may be used for future 3GPP V2X technologies using similar resource selection mechanisms (e.g., 6G V2X).

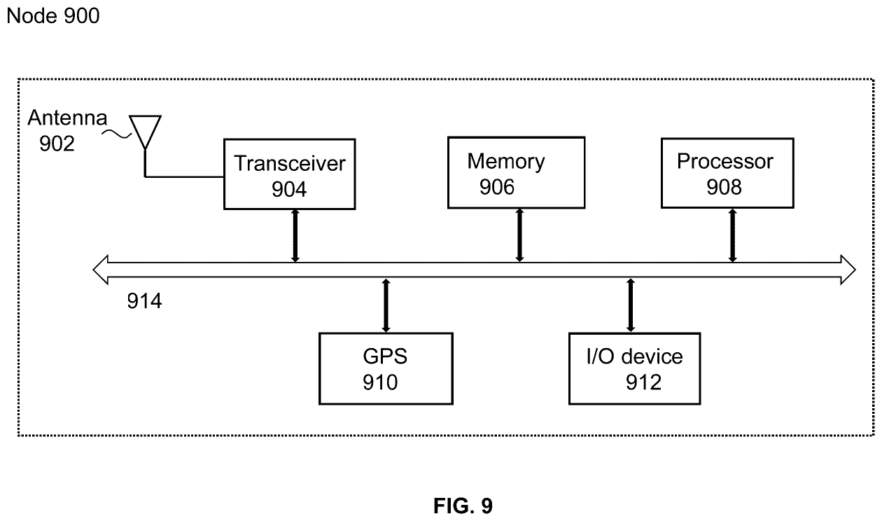

FIG. 9 is a block diagram of a node 900 for communication, consistent with some embodiments of the present disclosure. For example, the node 900 can be a UE, such as a Type A UE, a Type B UE, or a Type C UE as shown in FIG. 6. The node 900 can also be a base station, a road side unit, a relay node, or a mobile equipment. The node 900 may be mounted in a moving vehicle or in a fixed position. The node 900 may take any form, including but not limited to, a vehicle, a component mounted in a vehicle, a road-side unit, a computer system, a laptop computer, a wireless terminal including a mobile phone, a wireless handheld device, or wireless personal device, or any other form. Referring to FIG. 9, the node 900 may include antenna 902 that may be used for transmission or reception of electromagnetic signals to/from a base station or UEs. The antenna 902 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 902 may include multiple (e.g., tens or hundreds) antenna elements and may enable multi-antenna functions such as beamforming. In some embodiments, the antenna 902 is a single antenna.

The node 900 may include a transceiver 904 that is coupled to the antenna 902. The transceiver 904 may be a wireless transceiver at the node 900 and may communicate bi-directionally with a base station or UEs. For example, the node 900 is a UE in a sidelink communication and the transceiver 904 may receive/transmit wireless signals from/to a base station via downlink/uplink communication. The transceiver 904 may also receive/transmit wireless signals from/to another UE or a road side unit via sidelink communication. The transceiver 904 may include a modem to modulate the packets and provide the modulated packets to the antenna 902 for transmission, and to demodulate packets received from the antenna 902.

The node 900 may include a memory 906. The memory 906 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAN), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 906 may store information related to identities of node 900 and the signals and/or data received by antenna 902. The memory 906 may also store post-processing signals and/or data. The memory 906 may also store computer-readable program instructions, mathematical models, and algorithms that are used in signal processing in transceiver 904 and computations in processor 908. The memory 906 may further store computer-readable program instructions for execution by processor 908 to operate node 900 to perform various functions described in this disclosure. In some embodiments, the memory 906 may include a basic input/output system (BIOS) which may control basic hardware or software operation such as the interaction with peripheral components or devices. In some embodiments, the node 900 is a Type A UE, as shown in FIG. 6, and the memory 906 includes both the first SL module (e.g., NR SL module) and the second SL module (e.g., LTE SL module). In some embodiments, the node 900 is a Type B UE, as shown in FIG. 6, and the memory 906 includes an NR SL module only. In some embodiments, the node 900 is a Type C UE, as shown in FIG. 6, and the memory 906 includes an LTE SL module only. As mentioned above, in some embodiments, the node 900 may be a base station, a road side unit, a relay node, or a mobile equipment.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

The node 900 may include a processor 908 that may include a hardware device with processing capabilities. The processor 908 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 908 may be implemented using a combination of devices (e.g., a combination of a DSP and a microprocessor, multiple microprocessors, one or more microprocessors in conjunction with a DSP core, or any other such configuration). The processor 908 may receive, from transceiver 904, downlink signals or sidelink signals and further process the signals. The processor 908 may also receive, from transceiver 904, data packets and further process the packets. In some embodiments, the processor 908 may be configured to operate a memory using a memory controller. In some embodiments, a memory controller may be integrated into the processor 908. The processor 908 may be configured to execute computer-readable instructions stored in a memory (e.g., the memory 906) to cause the node 900 to perform various functions.

The node 900 may include a global positioning system (GPS) 910. The GPS 910 may be used for enabling location-based services or other services based on a geographical position of the node 900 and/or synchronization among UEs. The GPS 910 may receive global navigation satellite systems (GNSS) signals from a single satellite or a plurality of satellite signals via the antenna 902 and provide a geographical position of the node 900 (e.g., coordinates of the node 900). In some embodiments, the GPS 910 may be omitted.

The node 900 may include an input/output (I/O) device 912 that may be used to communicate the result of signal processing and computation to a user or another device. The I/O device 912 may include a user interface including a display and an input device to transmit a user command to processor 908. The display may be configured to display a status of signal reception at the node 900, the data stored at memory 906, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The node 900 may further include a machine interface 914, such as an electrical bus that connects the transceiver 904, the memory 906, the processor 908, the GPS 910, and the I/O device 912.

In some embodiments, the node 900 may be configured to or programmed to provide one or more resource indications. For example, the node 900 may be configured or programmed to: determine an overlap between a first resource reserved by a first node and a second resource reserved by a second node; and transmit one or more indications indicating the overlap between the first resource and the second resource.

In some embodiments, the node 900 may be configured to or programmed to obtain resource indications in a communication. For example, the node 900 may be configured to or programmed to: reserve a first resource for the communication; receive one or more indications indicating an overlap between the reserved first resource and a second resource reserved by a second node; and perform an adjustment based on the one or more indications so as to mitigate an effect of the overlap. As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1. A method for providing a resource indication in a communication, comprising:
determining an overlap between a first resource reserved by a first node and a second resource reserved by a second node; and
transmitting one or more indications indicating the overlap between the first resource and the second resource.

Clause 2. The method of Clause 1, wherein at least one of the first node or the second node is a user equipment (UE) in a sidelink communication.

Clause 3. The method of Clause 1, wherein at least one of the first node or the second node is a base station.

Clause 4. The method of Clause 1, wherein the first node is a UE, and the second node is a base station.

Clause 5. The method of Clause 1, wherein the one or more indications are transmitted to the first node, or a third node that is different from the first and second nodes.

Clause 6. The method of Clause 1, wherein the overlap between the first resource and the second resource is determined by at least one of the second node, or a third node that is different from the first and second nodes.

Clause 7. The method of Clause 1, wherein the first node comprises a first module for a first sidelink communication and a second module for a second sidelink communication, and the overlap between the first resource and the second resource is determined by the first module of the first node and transmitted to the second module of the first node.

Clause 8. The method of Clause 1, wherein the one or more indications are transmitted over at least one of: a physical sidelink feedback channel (PSFCH), a physical sidelink shared channel (PSSCH), a physical sidelink control channel (PSCCH), or a medium access control (MAC) control element (CE).

Clause 9. The method of Clause 1, wherein the first resource and the second resource are resources for a same radio access technology (RAT), and the one or more indications further comprise an indication indicating the same RAT.

Clause 10. The method of Clause 1, wherein the first resource is a resource for a first RAT, the second resource is a resource for a second RAT that is different from the first RAT, and the one or more indications further comprise an indication indicating the first RAT and the second RAT being different from one another.

Clause 11. The method of Clause 10, wherein the first RAT is a new radio (NR) and the second RAT is a long-term evolution (LTE).

Clause 12. The method of Clause 1, wherein the one or more indications comprise a plurality of indications, wherein each of the plurality of indications corresponds to at least one of: a percentage of the overlap in a time domain, a percentage of the overlap in a frequency domain, or an overall percentage of the overlap in the time domain and in the frequency domain.

Clause 13. The method of Clause 1, wherein each of the first resource and the second resource comprises at least one of: one or more slots, one or more subframes, one or more frames, one or more subchannels, one or more channels, or one or more resource blocks.

Clause 14. The method of Clause 1, wherein the one or more indications comprise at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

Clause 15. The method of Clause 1, wherein the one or more indications comprise a plurality of indications including a first indication and a second indication, the first indication indicating a higher level of the overlap than the second indication, and at least a portion of the first resource is vacated or excluded if the first node receives N1 times of the first indication, or if the first node receives N2 times of the second indication, where N1 and N2 are integers and N1 is smaller than N2.

Clause 16. The method of Clause 15, wherein the N1 and the N2 are configured by a network or pre-configured in the first node.

Clause 17. The method of Clause 1, wherein the one or more indications comprise a plurality of indications, each of the plurality of indications being assigned a priority or a relative priority.

Clause 18. A method for obtaining one or more resource indications in a communication, comprising:
reserving, by a first node, a first resource for the communication; receiving, by the first node, one or more indications indicating an overlap between the reserved first resource and a second resource reserved by a second node; and
performing, by the first node, an adjustment based on the one or more indications so as to mitigate an effect of the overlap.

Clause 19. The method of Clause 18, wherein performing the adjustment based on the one or more indications comprises at least one of:
determining whether to vacate at least a portion of the reserved first resource;
determining whether to exclude at least a portion of a resource to be selected;
changing a modulation and coding scheme (MCS) for the first node;
changing a transmit power for the first node; or
performing a retransmission using an alternative resource reservation.

Clause 20. The method of Clause 18, wherein at least one of the first node or the second node is a UE in a sidelink communication.

Clause 21. The method of Clause 18, wherein at least one of the first node or the second node is a base station.

Clause 22. The method of Clause 18, wherein the first node is a UE, and the second node is a base station.

Clause 23. The method of Clause 18, wherein the one or more indications are transmitted to the first node, or a third node that is different from the first and second nodes.

Clause 24. The method of Clause 18, wherein the one or more indications are received from at least one of: the first node, the second node, or a third node.

Clause 25. The method of Clause 24, wherein each of the first node, the second node, and the third node is at least one of: a UE, a base station, a road side unit, a relay node, or a mobile equipment.

Clause 26. The method of Clause 18, wherein the one or more indications are received over at least one of: a physical sidelink feedback channel (PSFCH), a physical sidelink shared channel (PSSCH), a physical sidelink control channel (PSCCH), or a medium access control (MAC) control element (CE).

Clause 27. The method of Clause 18, wherein the first resource and the second resource are resources for a same radio access technology (RAT), and the one or more indications further comprise an indication indicating the same RAT.

Clause 28. The method of Clause 18, wherein the first resource is a resource for a first RAT, the second resource is a resource for a second RAT that is different from the first RAT, and the one or more indications further comprise an indication indicating the first RAT and the second RAT being different from one another.

Clause 29. The method of Clause 28, wherein the first RAT is a new radio (NR) and the second RAT is a long-term evolution (LTE).

Clause 30. The method of Clause 18, wherein the one or more indications comprise a plurality of indications, each of the plurality of indications corresponding to at least one of: a percentage of the overlap in a time domain, a percentage of the overlap in a frequency domain, or an overall percentage of the overlap in the time domain and in the frequency domain.

Clause 31. The method of Clause 18, wherein each of the first resource and the second resource comprises at least one of: one or more slots, one or more subframes, one or more frames, one or more subchannels, one or more channels, or one or more resource blocks.

Clause 32. The method of Clause 18, wherein the one or more indications comprise at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

Clause 33. The method of Clause 18, wherein the one or more indications include a plurality of indications including a first indication and a second indication, the first indication indicating a higher level of the overlap than the second indication, and at least a portion of the first resource is vacated or excluded if the first node receives N1 times of the first indication, or if the first node receives N2 times of the second indication, where N1 and N2 are integers and N1 is smaller than N2.

Clause 34. The method of Clause 33, wherein the N1 and the N2 are configured by a network or pre-configured in the first node.

Clause 35. The method of Clause 19, wherein the one or more indications comprise a plurality of indications, and performing the adjustment based on the one or more indications comprises changing the MCS for the first node based on the plurality of the indications, and wherein the MCS corresponds to at least one of a type or a number of the one or more indications.

Clause 36. The method of Clause 18, further comprising: considering priorities or relative priorities of transmissions scheduled to use the first resource.

Clause 37. The method of Clause 18, further comprising: considering the one or more indications only when a distance between the first node and an apparatus at which the overlap is determined is smaller than a threshold distance.

Clause 38. The method of Clause 19, wherein performing the adjustment based on the one or more indications comprises changing the transmit power for the first node based on the plurality of the indications, and wherein a reduced transmit power is used for a transmission having a lower priority, and increased transmit power is used for a transmission having a higher priority.

Clause 39. The method of Clause 18, wherein the one or more indications comprise a plurality of indications transmitted from a single apparatus at a same time or at different times.

Clause 40. The method of Clause 18, wherein the one or more indications comprise a plurality of indications transmitted from a plurality of different apparatuses.

Clause 41. The method of Clause 18, wherein the one or more indications comprise a plurality of indications, and the method further comprises:
aggregating the plurality of indications at least in one of a time domain or a frequency domain, so as to generate at least one of a time domain aggregation or a frequency domain aggregation;
determining whether a percentage of an overlap of at least one of the time domain aggregation or the frequency domain aggregation is greater than a time domain threshold or a frequency domain threshold, wherein the time domain threshold and the frequency domain threshold are configured or pre-configured; and
vacating or excluding at least one resource in the time domain or the frequency domain, in response to a determination that the percentage of the overlap of at least one of the time domain aggregation or the frequency domain aggregation is greater than the time domain threshold or the frequency domain threshold.

Clause 42. An apparatus for providing one or more resource indications, the apparatus comprising:
a memory storing an instruction; and
a processor configured to execute the instruction stored in the memory to:
determine an overlap between a first resource reserved by a first node and a second resource reserved by a second node; and
transmit one or more indications indicating the overlap between the first resource and the second resource.

Clause 43. The apparatus of Clause 42, wherein at least one of the first node or the second node is a user equipment (UE) in a sidelink communication.

Clause 44. The apparatus of Clause 42, wherein at least one of the first node or the second node is a base station.

Clause 45. The apparatus of Clause 42, wherein the first node is a UE, and the second node is a base station.

Clause 46. The apparatus of Clause 42, wherein the apparatus is the first node, the second node, or a third node that is different from the first and second nodes.

Clause 47. The apparatus of Clause 42, wherein the one or more indications are transmitted to the first node, or a third node that is different from the first and second nodes.

Clause 48. The apparatus of Clause 46, wherein the apparatus is the first node, and wherein the first node comprises a first module for a first sidelink communication and a second module for a second sidelink communication, and the overlap between the first resource and the second resource is determined by the first module of the first node and transmitted to the second module of the first node.

Clause 49. The apparatus of Clause 42, wherein the one or more indications are transmitted over at least one of: a physical sidelink feedback channel (PSFCH), a physical sidelink shared channel (PSSCH), a physical sidelink control channel (PSCCH), or a medium access control (MAC) control element (CE).

Clause 50. The apparatus of Clause 42, wherein the first resource and the second resource are resources for a same radio access technology (RAT), and the one or more indications further comprise an indication indicating the same RAT.

Clause 51. The apparatus of Clause 42, wherein the first resource is a resource for a first RAT, the second resource is a resource for a second RAT that is different from the first RAT, and the one or more indications further comprise an indication indicating the first RAT and the second RAT being different from one another.

Clause 52. The apparatus of Clause 51, wherein the first RAT is a new radio (NR) and the second RAT is a long-term evolution (LTE).

Clause 53. The apparatus of Clause 42, wherein the one or more indications comprise a plurality of indications, and wherein each of the plurality of indications corresponds to at least one of: a percentage of the overlap in a time domain, a percentage of the overlap in a frequency domain, or an overall percentage of the overlap in the time domain and in the frequency domain.

Clause 54. The apparatus of Clause 42, wherein each of the first resource and the second resource comprises at least one of: one or more slots, one or more subframes, one or more frames, one or more subchannels, one or more channels, or one or more resource blocks.

Clause 55. The apparatus of Clause 42, wherein the one or more indications comprise at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

Clause 56. The apparatus of Clause 42, wherein the one or more indications comprise a plurality of indications including a first indication and a second indication, the first indication indicating a higher level of the overlap than the second indication, and at least a portion of the first resource is vacated or excluded if the first node receives N1 times of the first indication, or if the first node receives N2 times of the second indication, where N1 and N2 are integers and N1 is smaller than N2.

Clause 57. The apparatus of Clause 56, wherein the N1 and the N2 are configured by a network or pre-configured in the first node.

Clause 58. The apparatus of Clause 42, wherein the one or more indications comprise a plurality of indications, each of the plurality of indications being assigned a priority or a relative priority.

Clause 59. A first node for obtaining resource indications in a communication, the first node comprising:
a memory storing an instruction; and
a processor configured to execute the instruction stored in the memory to:
reserve a first resource for the communication;
receive one or more indications indicating an overlap between the reserved first resource and a second resource reserved by a second node; and
perform an adjustment based on the one or more indications so as to mitigate an effect of the overlap.

Clause 60. The first node of Clause 59, wherein performing the adjustment based on the one or more indications comprises at least one of:
determining whether to vacate at least a portion of the reserved first resource;
determining whether to exclude at least a portion of a resource to be selected;
changing a modulation and coding scheme (MCS) for the first node;
changing a transmit power for the first node; or
performing a retransmission using an alternative resource reservation.

Clause 61. The first node of Clause 59, wherein at least one of the first node or the second node is a UE in a sidelink communication.

Clause 62. The first node of Clause 59, wherein at least one of the first node or the second node is a base station.

Clause 63. The first node of Clause 59, wherein the first node is a UE, and the second node is a base station.

Clause 64. The first node of Clause 59, wherein the one or more indications are received from at least one of: the second node, or a third node that is different from the first and second nodes.

Clause 65. The first node of Clause 64, wherein each of the first node, the second node, and the third node is at least one of: a UE, a base station, a road side unit, a relay node, or a mobile equipment.

Clause 66. The first node of Clause 59, wherein the one or more indications are received over at least one of: a physical sidelink feedback channel (PSFCH), a physical sidelink shared channel (PSSCH), a physical sidelink control channel (PSCCH), or a medium access control (MAC) control element (CE).

Clause 67. The first node of Clause 59, wherein the first resource and the second resource are resources for a same radio access technology (RAT), and the one or more indications further comprise an indication indicating the same RAT.

Clause 68. The first node of Clause 59, wherein the first resource is a resource for a first RAT, the second resource is a resource for a second RAT that is different from the first RAT, and the one or more indications further comprise an indication indicating the first RAT and the second RAT being different from one another.

Clause 69. The first node of Clause 68, wherein the first RAT is a new radio (NR) and the second RAT is a long-term evolution (LTE).

Clause 70. The first node of Clause 59, wherein the one or more indications comprise a plurality of indications, each of the plurality of indications corresponding to at least one of: a percentage of the overlap in a time domain, a percentage of the overlap in a frequency domain, or an overall percentage of the overlap in the time domain and in the frequency domain.

Clause 71. The first node of Clause 59, wherein each of the first resource and the second resource comprises at least one of: one or more slots, one or more subframes, one or more frames, one or more subchannels, one or more channels, or one or more resource blocks.

Clause 72. The first node of Clause 59, wherein the one or more indications comprise at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

Clause 73. The first node of Clause 59, wherein the one or more indications include a plurality of indications including a first indication and a second indication, the first indication indicating a higher level of the overlap than the second indication, and at least a portion of the first resource is vacated or excluded if the first node receives N1 times of the first indication, or if the first node receives N2 times of the second indication, where N1 and N2 are integers and N1 is smaller than N2.

Clause 74. The first node of Clause 73, wherein the N1 and the N2 are configured by a network or pre-configured in the first node.

Clause 75. The first node of Clause 60, wherein the one or more indications comprise a plurality of indications, and performing the adjustment based on the one or more indications comprises changing the MCS for the first node based on the plurality of the indications, and wherein the MCS corresponds to at least one of a type or a number of the one or more indications.

Clause 76. The first node of Clause 59, wherein the processor is further configured to execute the instruction stored in the memory to:
consider priorities or relative priorities of transmissions scheduled to use the first resource.

Clause 77. The first node of Clause 59, wherein the processor is further configured to execute the instruction stored in the memory to:
consider the one or more indications only when a distance between the first node and an apparatus at which the overlap is determined is smaller than a threshold distance.

Clause 78. The first node of Clause 60, wherein performing the adjustment based on the one or more indications comprises changing the transmit power for the first node based on the plurality of the indications, and
wherein a reduced transmit power is used for a transmission having a lower priority, and increased transmit power is used for a transmission having a higher priority.

Clause 79. The first node of Clause 59, wherein the one or more indications comprise a plurality of indications transmitted from a single apparatus at a same time or at different times.

Clause 80. The first node of Clause 59, wherein the one or more indications comprise a plurality of indications transmitted from a plurality of different apparatuses.

Clause 81. The first node of Clause 59, wherein the one or more indications comprise a plurality of indications, and wherein the processor is further configured to execute the instruction stored in the memory to:
aggregate the plurality of indications at least in one of a time domain or a frequency domain, so as to generate at least one of a time domain aggregation or a frequency domain aggregation;
determine whether a percentage of an overlap of at least one of the time domain aggregation or the frequency domain aggregation is greater than a time domain threshold or a frequency domain threshold, wherein the time domain threshold and the frequency domain threshold are configured or pre-configured; and
vacate or exclude at least one resource in the time domain or the frequency domain, in response to a determination that the percentage of the overlap of at least one of the time domain aggregation or the frequency domain aggregation is greater than the time domain threshold or the frequency domain threshold.

Clause 82. A non-transitory computer-readable medium storing instructions that are executable by one or more processors of an apparatus for communication, to perform a method, the method comprising:
determining an overlap between a first resource reserved by a first node and a second resource reserved by a second node; and
transmitting one or more indications indicating the overlap between the first resource and the second resource.

Clause 83. A non-transitory computer-readable medium storing instructions that are executable by one or more processors of a first node for a communication, to perform a method, the method comprising:
reserving a first resource for the communication;
receiving one or more indications indicating an overlap between the reserved first resource and a second resource reserved by a second node; and
performing an adjustment based on the one or more indications so as to mitigate an effect of the overlap.

1. A method for providing a resource indication in a communication, comprising:
determining an overlap between a first resource reserved by a first node and a second resource reserved by a second node; and
transmitting one or more indications indicating the overlap between the first resource and the second resource.

2. The method of claim 1, wherein the one or more indications are transmitted to the first node, or a third node that is different from the first and second nodes.

3. The method of claim 1, wherein the overlap between the first resource and the second resource is determined by at least one of the second node, or a third node that is different from the first and second nodes.

4. The method of claim 1, wherein the first node comprises a first module for a first sidelink communication and a second module for a second sidelink communication, and the overlap between the first resource and the second resource is determined by the first module of the first node and transmitted to the second module of the first node.

5. The method of claim 1, wherein the one or more indications are transmitted over at least one of: a physical sidelink feedback channel (PSFCH), a physical sidelink shared channel (PSSCH), a physical sidelink control channel (PSCCH), or a medium access control (MAC) control element (CE).

6. The method of claim 1, wherein the first resource and the second resource are resources for a same radio access technology (RAT), and the one or more indications further comprise an indication indicating the same RAT.

7. The method of claim 1, wherein the first resource is a resource for a first RAT, the second resource is a resource for a second RAT that is different from the first RAT, and the one or more indications further comprise an indication indicating the first RAT and the second RAT being different from one another.

8. The method of claim 1, wherein the one or more indications comprise a plurality of indications,
wherein each of the plurality of indications corresponds to at least one of: a percentage of the overlap in a time domain, a percentage of the overlap in a frequency domain, or an overall percentage of the overlap in the time domain and in the frequency domain.

9. The method of claim 1, wherein the one or more indications comprise at least one of: an indication of an overlap of at least a portion of reserved channels, an indication of an overlap of at least a portion of reserved subchannels, an indication of an overlap of at least a portion of reserved frames, an indication of an overlap of at least a portion of reserved subframes, or an indication of an overlap of at least a portion of reserved slots.

10. The method of claim 1, wherein the one or more indications comprise a plurality of indications including a first indication and a second indication, the first indication indicating a higher level of the overlap than the second indication, and at least a portion of the first resource is vacated or excluded if the first node receives N1 times of the first indication, or if the first node receives N2 times of the second indication, where N1 and N2 are integers and N1 is smaller than N2.

11. The method of claim 1, wherein the one or more indications comprise a plurality of indications, each of the plurality of indications being assigned a priority or a relative priority.

12. A method for obtaining one or more resource indications in a communication, comprising:
reserving, by a first node, a first resource for the communication;
receiving, by the first node, one or more indications indicating an overlap between the reserved first resource and a second resource reserved by a second node; and
performing, by the first node, an adjustment based on the one or more indications so as to mitigate an effect of the overlap.

13. The method of claim 12, wherein performing the adjustment based on the one or more indications comprises at least one of:
determining whether to vacate at least a portion of the reserved first resource;
determining whether to exclude at least a portion of a resource to be selected;
changing a modulation and coding scheme (MCS) for the first node;
changing a transmit power for the first node; or
performing a retransmission using an alternative resource reservation.

14. The method of claim 13, wherein the one or more indications comprise a plurality of indications, and performing the adjustment based on the one or more indications comprises changing the MCS for the first node based on the plurality of the indications, and
wherein the MCS corresponds to at least one of a type or a number of the one or more indications.

15. The method of claim 12, further comprising:
considering priorities or relative priorities of transmissions scheduled to use the first resource.

16. The method of claim 12, further comprising:
considering the one or more indications only when a distance between the first node and an apparatus at which the overlap is determined is smaller than a threshold distance.

17. The method of claim 13, wherein performing the adjustment based on the one or more indications comprises changing the transmit power for the first node based on the plurality of the indications, and
wherein a reduced transmit power is used for a transmission having a lower priority, and increased transmit power is used for a transmission having a higher priority.

18. The method of claim 12, wherein the one or more indications comprise a plurality of indications, and the method further comprises:
aggregating the plurality of indications at least in one of a time domain or a frequency domain, so as to generate at least one of a time domain aggregation or a frequency domain aggregation;
determining whether a percentage of an overlap of at least one of the time domain aggregation or the frequency domain aggregation is greater than a time domain threshold or a frequency domain threshold, wherein the time domain threshold and the frequency domain threshold are configured or pre-configured; and
vacating or excluding at least one resource in the time domain or the frequency domain, in response to a determination that the percentage of the overlap of at least one of the time domain aggregation or the frequency domain aggregation is greater than the time domain threshold or the frequency domain threshold.

19. An apparatus for providing one or more resource indications, the apparatus comprising:
a memory storing an instruction; and
a processor configured to execute the instruction stored in the memory to:
determine an overlap between a first resource reserved by a first node and a second resource reserved by a second node; and
transmit one or more indications indicating the overlap between the first resource and the second resource.

20. (canceled)
